(19) United States
(12) Patent Application Publication
(10) Pub. No.: US 2004/0255302 A1
(43) Pub. Date: Dec. 16, 2004

(54) Systems and methods for content and service registration, query and subscription, and notification across local service discovery domains

(75) Inventor: Dirk Trossen, Cambridge, MA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/457,866

(22) Filed: Jun. 10, 2003

(51) Int. Cl. G06F 9/46

(52) U.S. Cl. 719/318

(57) ABSTRACT

A system and method are provided for subscribing to an event across a local service discovery domain. The system includes a first network entity capable of transmitting a subscription message subscribing to the event, and including an event package description, an event type description, and a description for a service or a content requested. A local event server is capable of receiving the subscription message, and thereafter transmit a subscription message. A remote event server, located in a different local service discovery domain than the local event server, can receive the subscription message from the local event server, and thereafter send a first notify message to the first network entity and/or the local event server.

### FIELD OF THE INVENTION

The present invention relates generally to telecommunications networks and, more particularly, relates to systems and methods for content and service registration, query and subscription, and notification in networks and across local service discovery domains.

### BACKGROUND OF THE INVENTION

In a network environment, it is often important for devices to discover available services in the network and to learn information about the configuration of those services. Service discovery, therefore, has been a topic for research and standardization for several years. As a result, protocols and products have been developed to allow for registration and discovery of services. Examples include the Internet protocol known as Service Location Protocol (SLP), the JINI™ architecture (a set of JAVA® application program interfaces (APIs) that enable a device to announce itself on a network and to provide some details about its capabilities), and the networking architecture known as Universal Plug and Play (UPnP). These protocols and products, however, do not typically provide for the discovery of content available in respective networks. They further do not allow crossing their local service discovery boundaries, i.e., they do not support the formation of federations of discovery systems.

One of the common architectural foundations for service discovery solutions is the existence of a service discovery agent (service agent), such as described in the Internet Engineering Task Force (IETF) request for comment document RFC 2608, entitled: Service Location Protocol, version 2, June 1999, the contents of which are hereby incorporated by reference in its entirety. These agents typically serve a logical, administrative domain in which services subscribe with such agents to offer functionality to other entities. Services can be requested, i.e., discovered, by sending an appropriate request to a service agent that matches the requirements of the request against its repository of internal service subscription data. Although this general architecture may be common, particular embodiments differ in important details such as protocol messages, representation format for services, and objectives with respect to the particular environment. Accordingly, dedicated protocol stacks must be present for each different embodiment.

Multicast-based solutions, such as JINI™ and UPnP, or multicast mode versions of SLP, seek to avoid the existence of a centralized service agent. However, these solutions also suffer from certain drawbacks. For example, such multi-cast solutions generally require specific delivery paradigms. Additionally, they are typically inefficient due to flooding of service requests, hence their applicability is restricted to particular scenarios.

On a related topic, calling models such as Session Initiation Protocol (SIP) and ITU H.323 multimedia conferencing standard provide application layer signaling protocols related to multimedia sessions (see, e.g., IETF request for comment document RFC 3261, entitled: SIP: Session Initiation Protocol, July 2002, the contents of which are hereby incorporated by reference in its entirety). SIP was generally developed to allow for initiating a session between two or more endpoints in the Internet by making these endpoints aware of the session semantics. Accordingly, devices (or users that run certain applications on these devices) are registered with the SIP backbone so that an invitation to a particular session can be correctly delivered to these endpoints. To achieve this, SIP provides a registration mechanism for devices and users, and it applies mechanisms such as location servers and registrars to route the session invitations appropriately. SIP currently provides methods for discovering certain capabilities for known endpoints (i.e., an OPTIONS method for querying a server as to its capabilities for a user); however, this does not apply to unknown endpoints.

Methods have been proposed for integrating service registration and discovery with device registration, such as in a SIP environment. However, such methods generally require extensions to standards for device registration, as well as to products using such device registration standards. Further, such methods do not provide for notifications to be sent to subscribed users in the case that new services become available. They also do not provide for tracking changing availability or de-registration of desired services/content.

Event registration and trigger notification have been proposed as an extension of SIP (see, e.g., IETF request for comment document RFC 3265, entitled: SIP-Specific Event Notification, July 2002, the contents of which are hereby incorporated by reference in its entirety). Such a proposal, however, does neither specify the semantics of specific events, nor systems and methods for uploading event information. Further, such a proposal does not specifically address systems and methods for tracking changes in the registration and de-registration of services and/or content. Additionally, such a proposal does not address systems and methods for requesting (and removing a request for) notification of service and/or content requests (i.e. report of service/content requests from other devices or entities).

Uploading SIP event information has been addressed in SIMPLE Presence Publication Mechanism, Work In Progress, IETF Draft, October 2002, the contents of which are hereby incorporated by reference in its entirety. However, the mechanism aims at publishing presence information rather than specifically addressing registration of service/content information. Further, it leaves the handling of the uploaded information to the implementation of the presence server, i.e., it does not enforce a certain usage of the uploaded information.

One technique that has been developed to address the aforementioned problems is disclosed in U.S. patent application Ser. No. 10/330,146, entitled: Content and Service Registration, Query and Subscription, and Notification in Networks, filed Dec. 30, 2002, the contents of which are hereby incorporated by reference in its entirety. As disclosed, the technique permits substantially uniform registration of content and services between different discovery protocols, as well as the substantially uniform querying of contents and services. The technique disclosed by U.S. patent application Ser. No. 10/330,146 also provides for tracking of changing registration and de-registration of desired services and/or contents. In addition, the technique provides for requesting, un-requesting, and notifying of service and/or content requests. And although the technique addresses the aforementioned problems, it is always desirable to improve upon existing techniques.

### SUMMARY OF THE INVENTION

In light of the foregoing background, embodiments of the present invention provide systems and methods for content and service registration, query and subscription, and notification across local service discovery domains. In this regard, a service discovery domain may be defined in any of a number of different manners, such as administratively in the case of an IP subnet. Alternatively, the service discovery domain can be defined according to a physical property, such as the range of a wireless network. Embodiments of the present invention therefore facilitate discovery of content and services across local service discovery domains, particularly in instances in which a requestor of such content or services is located outside the local service discovery domain of the requested content or services.

According to one aspect of the present invention, a system is provided for subscribing to an event across a local service discovery domain. The system includes a first network entity, such as a requester, capable of transmitting a subscription message, such as a session initiation protocol (SIP) SUBSCRIBE message subscribing to the event. The subscription message includes an event package description, an event type description (e.g., a registered type, a published type, and/or a de-registered type), and a description for a service or a content requested. The subscription message can also include an expiration time for expiration of the subscription to the event. The subscription message can include a description for a service or a content requested in an attribute-based format, such as Service Location Protocol (SLP), and or using descriptions such as according to the Resource Description Framework (RDF).

The system also includes a local event server, such as a SIP event server, capable of receiving the subscription message, and thereafter transmitting a subscription message, where as before, the subscription message includes the event package, the corresponding event type and the service or content requested. In this regard, the local event server can be capable of checking for a match for the event package, the corresponding event type, and the service or content requested, and thereafter transmit the subscription message when no match is located. In one particularly advantageous embodiment, the local event server is capable of checking a cache for a match before transmitting the subscription message when no match is located for the event package, the corresponding event type, and the service or content requested. Then, the local event server transmits the subscription message when no match is found in the cache. If a match is found in the cache, however, the local event server is capable of sending a first notify message to the first network entity.

The system further includes a remote event server, in a federation of service discovery agents, located in a different local service discovery domain than the local event server. The remote event server is capable of receiving the subscription message from the local event server. Thereafter, the remote event server is capable of sending a first notify message, such as a SIP NOTIFY message, to at least one of the local event server and the first network entity. Before sending the first notify message, the remote server can check for a match for the event package, the corresponding event type, and the one of the service and content requested. Then, the remote server is capable of sending a first notify message indicating whether the match was located.

The system can further include a repository capable of receiving, from the local event server, a discovery message requesting information about at least one provider matching the service or content requested. The repository can then check for a match for the service and/or content requested, and thereafter transmit a discovery response containing an indication of a non-existing match or at least one provider at least partially matching the service or content requested. The local event server can receive the discovery response to thereby check for a match.

The system can also include a provider capable of transmitting, to the remote event server, a register message comprising an event package description describing an event package comprising a service event package or a content event package, an event type description describing a register event type, and a service or content capability for the provider. The remote event server can then be capable of checking for a service/content match of the service or the content capability information for the provider. Thereafter, the remote event server is capable of notifying the first network entity when a service/content match is located and the service/content match includes at least a partial match with the service or the content requested by the requester.

More particularly, presume that a provider is capable of transmitting a register message including service or content capability information for the provider and an event type description describing a de-register event type. Also presume that the service and content capability information for the provider matches the service and content requested for the requester. In such an instance, the remote event server is capable of checking for a service/content match of the service or content capability information for the provider, such as by comparing the service and content capability information for the provider with a subscription database. Thereafter, the remote event server can notify the requester of the de-registered state of the provider when the service/content match is located.

The remote event server is capable of receiving a register message from a second network entity, where the register message comprises service or content capability information for the second network entity at least partially matching the service or content requested from the first network entity. In such an instance, the remote event server is capable of sending a second notify message notifying the first network entity of the match with the service or content capability information for the second network entity. When the subscription includes an expiration time, then, the remote event server is capable of sending the second notify message when the expiration time has not expired.

In one more particular embodiment, presume the first network entity is capable of transmitting a subscription message having an event type description comprising a requested type. In such instances, the system can further include a requester capable of transmitting a subscription message to the remote event server, where the subscription message comprises an event package description, an event type description describing one of a registered event type and a published event type, and a description for a service or a content requested. The remote event server can then be capable of checking for a service/content match of the service or the content requested by the requester, and thereafter notifying the provider of the subscription message from the requester when a service/content match is located and the match includes at least a partial match with the service or the content requested by the requester.

In another more particular embodiment, presume the first network entity is capable of transmitting a subscription message having an event type description comprising a request_removed type. In this instance, the system can further include a requester capable of transmitting a second subscription message to the remote event server, where the second subscription message requests removal of a first subscription request requesting the service or the content. The remote event server can then be capable of checking for a service/content match of the service or the content requested in the first subscription request by the requester. Thereafter, the remote event server can be capable of notifying the provider of the subscription removal message from the requester when a service/content match is located and the match includes at least a partial match with one of the service and the content requested by the requester.

A local event server and method for subscribing to an event maintained by a remote event server across a local service discovery domain are also provided. Embodiments of the present invention therefore permit substantially uniform subscription and querying of contents and services between different discovery protocols. Embodiments of the present invention also provide for tracking of changing registration and de-registration of desired services and/or contents. In addition, embodiments of the present invention provide for requesting, un-requesting, and notifying of service and/or content requests. Advantageously, embodiments of the present invention are capable of providing all of the aforementioned benefits across local service discovery domains by allowing a local event server to act as a requester of services and/or content across local service discovery domains. Embodiments of the present invention therefore facilitate discovery of content and services across local service discovery domains, particularly in instances in which a requestor of such content or services is located outside the local service discovery domain of the requested content or services. Therefore, the system and method of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 shows a system that supports registration, querying, subscription, and notification methods according to one embodiment of the present invention;

FIG. 2 is a schematic block diagram of a mobile station that may act as either a service/content provider, a local or remote SIP Event Server, or a requester according to embodiments of the present invention;

FIG. 3A shows a functional diagram of a server, which is representative of a local or remote SIP event server, or the local repository/service agent, according to one embodiment of the present invention;

FIG. 3B is an operational diagram of a server, which is representative of a local or remote SIP event server, according to one embodiment of the present invention;

FIG. 4 shows message flows between entities of the system for a service and/or content registration method according to an illustrative embodiment of the invention;

FIG. 5 shows a SIP REGISTER or SIP PUBLISH message according to one embodiment of the present invention;

FIG. 6 shows a SIP REGISTER or SIP PUBLISH message according to a further illustrative embodiment of the invention; and

FIGS. 7A and 7B show message flows between entities in a method of subscription/notification of service and/or content according to another illustrative embodiment of the invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

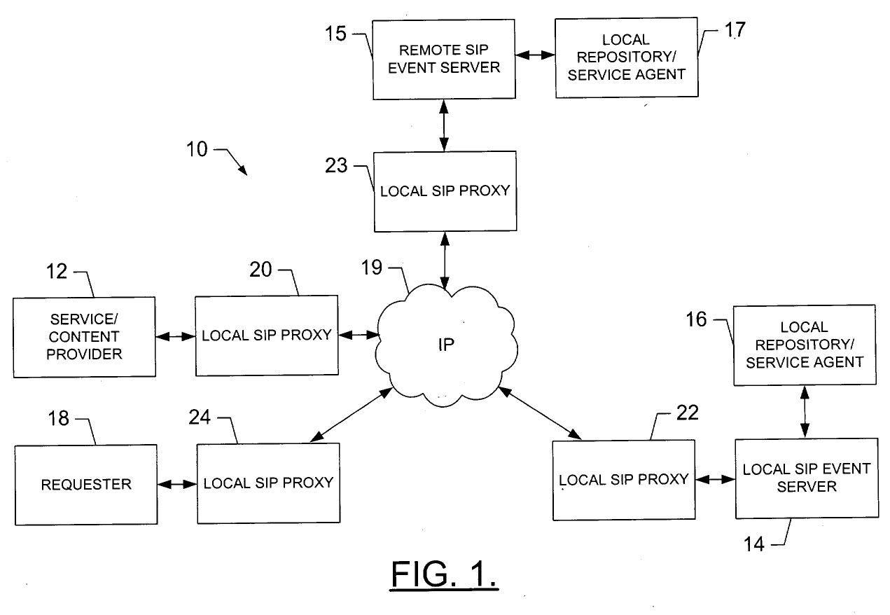

Referring now to FIG. 1, a general system 10 is shown that supports content and service registration, query, subscription, and notification in networks, and across local service discovery domains. The system generally includes a service/content provider 12, a local SIP event server 14, one or more remote SIP event servers 15 (one of which is shown), a requester 18, and an IP communications network 19 through which the service/content provider, the SIP event servers and the requester communicate. As shown and described below, the local SIP event server is in the local service discovery domain of the requester, while the remote SIP event server is in the local service discovery domain of the service/content provider. For a further description of instances in which the requester, service/content provider and the local SIP event server are co-located in a single local service discovery domain, see U.S. patent application Ser. No. 10/330,146.

The service/content provider 12 may include a mobile station or other devices having service and/or content capabilities, such as being able to support multimedia sessions of various parameters. The requester 18 may be any device or entity that requests service and/or content information related to one or more service/content providers. The local SIP event server 14 is in communication with one or more local repositories 16, each of which maintain a database of service and/or content subscriptions. Similarly, the remote SIP event server 15 is in communication with one or more local repositories 17, each of which also maintain a database of service and/or content subscriptions. Although shown as a one-to-one relationship, multiple local repositories may be in communication with local and/or remote SIP event servers. Further, each local repository may be in communication with multiple SIP event servers. Depending upon the local service directory of the service/content provider, the service/content provider is registered with one or more local repositories via local or remote SIP event servers for providing service/content communications to requester(s), such as the requester. Each local repository may include a local service discovery agent (service agent) that operates and maintains a repository for storing service/content information about service/content providers within a particular domain.

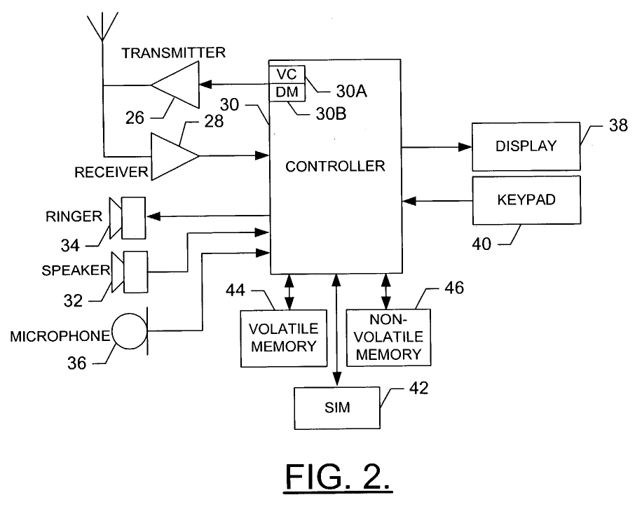

Referring now to FIG. 2, a functional diagram of a mobile station is shown that may act as either a service/content provider 12, a local or remote SIP Event Server 14, 15, or a requester 18 according to embodiments of the invention. It should be understood, that the mobile station illustrated and hereinafter described is merely illustrative of one type of mobile station that would benefit from the present invention and, therefore, should not be taken to limit the scope of the present invention. While several embodiments of the mobile station are illustrated and will be hereinafter described for purposes of example, other types of mobile stations, such as portable digital assistants (PDAs), pagers, laptop computers and other types of voice and text communications systems, can readily employ the present invention.

The mobile station includes a transmitter 26, a receiver 28, and a controller 30 that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of first, second and/or third-generation communication protocols or the like. For example, the mobile station may be capable of operating in accordance with second-generation (2G) wireless communication protocols IS-136 (TDMA), GSM, and IS-95 (CDMA). Some narrow-band AMPS (NAMPS), as well as TACS, mobile terminals may also benefit from the teaching of this invention, as should dual or higher mode phones (e.g., digital/analog or TDMA/CDMA/analog phones).

It is understood that the controller 30 includes the circuitry required for implementing the audio and logic functions of the mobile station. For example, the controller may be comprised of a digital signal processor device, a microprocessor device, and various analog to digital converters, digital to analog converters, and other support circuits. The control and signal processing functions of the mobile station are allocated between these devices according to their respective capabilities. The controller thus also includes the functionality to convolutionally encode and interleave message and data prior to modulation and transmission. The controller can additionally include an internal voice coder (VC) 30A, and may include an internal data modem (DM) 30B. Further, the controller may include the functionally to operate one or more software programs, which may be stored in memory. For example, the controller may be capable of operating a connectivity program, such as a conventional Web browser. The connectivity program may then allow the mobile station to transmit and receive Web content, such as according to the Wireless Application Protocol (WAP), for example.

The mobile station also comprises a user interface including a conventional earphone or speaker 32, a ringer 34, a microphone 36, a display 38, and a user input interface, all of which are coupled to the controller 30. The user input interface, which allows the mobile station to receive data, can comprise any of a number of devices allowing the mobile station to receive data, such as a keypad 40, a touch display (not shown) or other input device. In embodiments including a keypad, the keypad includes the conventional numeric (0-9) and related keys (#, *), and other keys used for operating the mobile station.

The mobile station can also include memory, such as a subscriber identity module (SIM) 42, a removable user identity module (R-UIM) or the like, which typically stores information elements related to a mobile subscriber. In addition to the SIM, the mobile station can include other memory. In this regard, the mobile station can include volatile memory 44, such as volatile Random Access Memory (RAM) including a cache area for the temporary storage of data. The mobile station can also include other non-volatile memory 46, which can be embedded and/or may be removable. The non-volatile memory can additionally or alternatively comprise an EEPROM, flash memory or the like. The memories can store any of a number of pieces of information, and data, used by the mobile station to implement the functions of the mobile station. For example, the memories can store an identifier, such as an international mobile equipment identification (IMEI) code, capable of uniquely identifying the mobile station, such as to a mobile switching center (MSC). Also, for example, the memories can store instructions for creating messages related to embodiments of the present invention, such as REGISTER, PUBLISH, or SUBSCRIBE messages, as described below.

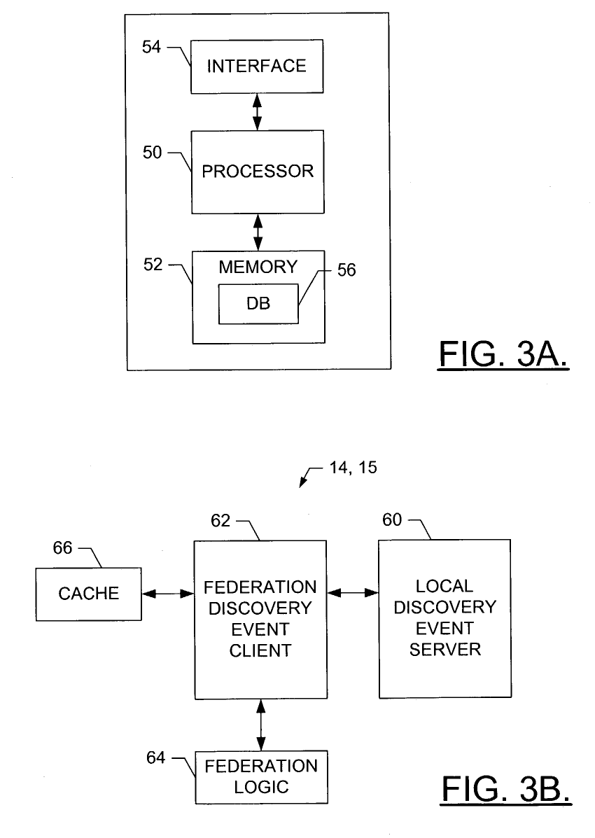

Referring now to FIG. 3A, a functional diagram of an entity that may act as local or remote SIP event server 14, 15, or a local repository/service agent 16, 17 is shown. Although shown as separate entities, in some embodiments, a single entity may support a logically separate, but co-located, SIP event server with a respective local repository/service agent. The entity acting as either the local or remote SIP event server, or a local repository/service agent generally includes a processor 50 connected to a memory 52 and an interface 54. The memory typically includes instructions for the processor to perform steps associated with service and/or content registration, discovery, and notification. Further, as a service agent, the memory may store a database (DB) 56 containing service and/or content registration information for devices or uniform resource identifiers (URIs). Additionally, as a SIP event server, the memory may store a local database containing subscription information for devices or URIs.

Reference is now made to FIG. 3B, which illustrates an operational diagram of a local or remote SIP event server 14, 15, with the difference between the SIP event servers typically being the local service discovery domain within which each operates. As described more fully below, the SIP event servers, and thus the local repository/service agents, of a number of different local service discovery domains can be associated with one another, or otherwise linked, into a federation of service discovery agents. As shown, the SIP event server operationally includes a local discovery event server 60, which may operate in accordance with U.S. patent application Ser. No. 10/330,146 to provide for content and service registration, query and subscription, and notification within the local service discovery domain of the respective SIP event server. In addition, the local discovery event server is capable of communicating with a federation discovery event client 62. For example, in case of an unsuccessful local discovery of a requested service or content at the respective SIP event server, the local discovery event server can transmit a notification that contains the requested service/content to the federation discovery event client. Additionally, or alternatively, for example, the local discovery event server can provide information of requested most popular services/content requests to the federation discovery event client. The most popular services/content can be determined in any of a number of different manners, such as according to history-based techniques.

The federation discovery event client 62, operating in accordance with federation logic 64, is capable of communicating with other SIP event servers, and thus local repository/service agents, in the federation of service discovery agents to thereby locate services/content across local service discovery domains. Logically, the federation discovery event client serves as a requester for services/content (or even entire categories of services/content) for service discovery requests across local service discovery domains. The federation discovery event client is capable of receiving the notification from the local discovery event server 60, and thereafter forwarding such requests to one or more known event servers within the federation of discovery agents in other local service discovery domains. In this regard, as described more fully below, the federation discovery event client operates in accordance with the federation logic to determine the remote event servers. Also, although the local discovery event server can provide information regarding the most popular services/content requests to the federation discovery event client, it will be appreciated that the federation discovery event client can additionally, or alternatively, request such information on-demand from the local discovery event server.

As indicated above, the federation logic 64 implements a mechanism to establish a federation of discovery agents, e.g., the local event server 14 and one or more remote event servers 15. In addition, the federation logic 64 is capable of determining, for a certain service/content discovery request (provided by the federation discovery event client 62), an appropriate set of other discovery agents that are part of the federation. The federation logic can establish the federation of discovery agents and determine the appropriate set of other discovery agents according to any of a number of different known techniques. According to one such technique, each discovery agent maintains a database (e.g., database 56) containing service and/or content registration information for devices or uniform resource identifiers (URIs) in the local service discovery domain of the respective discovery agent. Each discovery agent also maintains, however, a table of active links to the databases of other discovery agents. In this regard, a set of linked directories forms a data cluster that can be queried by requesters 18 for service and/or content information. For more information on such a technique for establishing a federation of discovery agents, see Paul Castro et al., Locating Application Data Across Service Discovery Domains, ACM SIGMOBILE MOBICOM 2001, 7th Annual Int'l Conference on Mobile Computing and Networking, Jul. 16-21, 2001, Rome, Italy, the contents of which are hereby incorporated by reference in its entirety.

In addition to the local discovery event server 60, the federation discovery event client 62 and the federation logic 64, the SIP event servers 14, 15 may additionally include a cache 66, which may be embodied in the memory 52 shown in FIG. 3A. As described in further detail below, the cache may facilitate optimization of service and/or content discovery by storing a listing of the services and/or content previously located at other SIP event servers. By storing such a listing, the SIP event server can consult the cache to locate a particular SIP event server that has registered the previously located services and content to thereby more narrowly search for requested services/content across local service discovery domains.

In accordance with embodiments of the present invention, the system 10 provides a session initiation protocol (SIP) framework. As such, the service/content provider 12, SIP event servers 14, 15 and the requester 18 are each registered with a corresponding local SIP proxy 20, 22, 23 and 24, respectively. Although shown as separate logical entities, local SIP event server 14, local repository 16, and/or SIP proxy 22 may be co-located. Likewise, the remote SIP event server 15, the local repository 17 and/or the SIP proxy 23 may be co-located. However, the SIP event servers are generally entities that are logically separate from respective SIP proxies 22, 23. In this regard, the SIP event servers generally perform service/content discovery using a protocol that can interact with various discovery protocols. As such, the SIP event servers act as intermediaries between the requester or the service/content provider, and the local repository/service agents 16 and 17, respectively. Based on the system, then, methods of service and/or content registration, query, subscription and notification according to the present invention may be practiced within a local service discovery domain or across local service discovery domains.

In general, the system 10 provides a common framework through which different service and/or content discovery systems may be integrated. As such, an end-user may transparently access several different types of service and/or content discovery systems. For example, the local repositories 16, 17 may operate as part of service discovery systems, such as systems using Service Location Protocol (SLP) or the JINI™ architecture. Without knowing the type of discovery system used with the local repositories 16, 17, the requester 18 may nonetheless discover an entity registered with either local repository 16, 17 that offers a desired service and/or content. Further, necessary parameters for the service/content may also be discovered with the same common discovery mechanism. Hence, the methods of embodiments of the present invention allow for integrating disparate discovery systems into a common discovery mechanism, as discussed below.

Using the system 10 as an example framework, a method for service and/or content registration according to one embodiment of the invention will be described below. As indicated above, the service/content provider registers with either the local SIP event server 14 or the remote SIP event server 15, depending upon the local service directory domain of the service/content provider. For purposes of clarity, however, the following description will presume the service/content provider is located in the same local service directory domain as the remote SIP event server. For more information on the service/content provider being located in the same local service directory domain as the local SIP event server, and thus registering with the local SIP event server, see U.S. patent application Ser. No. 10/330,146.

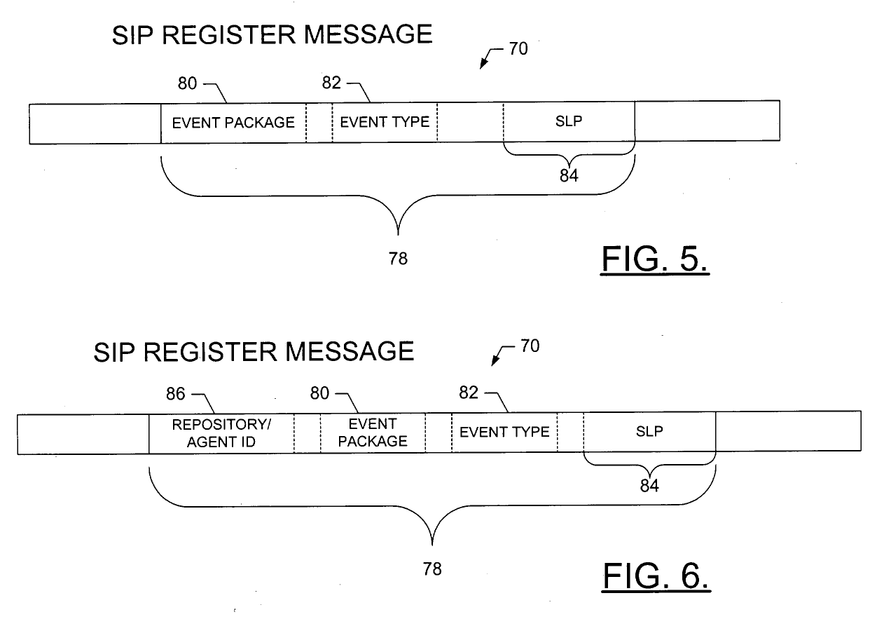

Briefly, according to one embodiment, the method generally includes the service/content provider 12 registering with the remote SIP event server 15 using a SIP REGISTER message 70 (shown in FIG. 5). In this regard, SIP REGISTER messages are generally used for registering a device with a SIP proxy. However, SIP REGISTER messages may be used for registering service and/or content of a device or entity with a SIP event server. Accordingly, the SIP REGISTER message includes service and/or content information about the service/content provider in the form of a payload 78 in the REGISTER message. The SIP message further contains information regarding the event package and event type, in accordance to IETF request for comment document RFC 3265, entitled: SIP-Specific Event Notification, July 2002, the contents of which are hereby incorporated by reference in its entirety. In this regard, the event package indicates that service or content registration is desired, e.g., through event package name “service” or “content.” And the event type, e.g., “register,” indicates the action to be taken, e.g., registration of the service. It is also possible, however, that the event package and event type information is extracted from the REGISTER message without being explicitly given in the message. The event package information can, for example, be obtained through recognizing whether the payload specifies a service or a content. Further, if the SIP REGISTER message registers the device, the event type “register” can be assumed, while a de-registration of the device, in accordance to IETF document RFC 3261, could assume a de-registration of the service/content as well. In turn, the remote SIP event server registers the service/content capabilities of the service/content provider with the local repository/service agent 17. As another embodiment, the SIP PUBLISH message can be used to register service/content capabilities with the remote SIP event server.

A method for service discovery according to one embodiment of the invention includes a requester 18 querying the local SIP event server for service/content capabilities. Upon reception of the query, the local SIP event server 14 queries local repository 16 for such information and, if the local repository has the information, the local SIP event server returns the requested information to requester. For more information on such an instance, see U.S. patent application Ser. No. 10/330,146. As described below, if the local repository does not have the information, however, the local SIP event server communicates with one or more remote SIP event servers in a federation of discovery agents to thereby locate the requested information. Then, if one or more of the remote SIP event servers have the information, the requested information is returned to the local SIP event server which, in turn, returns the information to the requester.

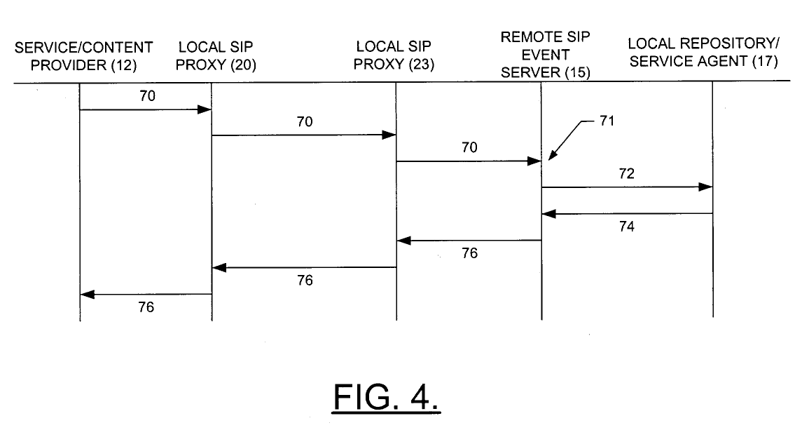

Referring now to FIG. 4 in particular, as well as FIGS. 1-3 in general, message flows for a service and/or content registration method according to one embodiment of the present invention are shown. As an example for use throughout the specification, suppose that the service/content provider 12 is an IP-enabled color printer, such as a color printer unit for a particular company. Suppose further that local repository/service agent 17 is an SLP-based service discovery agent for facility A (not shown) of the company and that it is a part of the company's private network at facility A. Suppose also that the remote SIP event server 15 is also located within the company's private network at facility A. Although the following description will apply to local repository/service agent 17 and remote SIP event server 15, it will be appreciated that the description could equally apply to local repository/service agent 16 and local SIP event server 14. In this regard, whether the service/content provider registers its services and/or content with the local or remote SIP event server, and thus local repository/service agent 16 or 17, depends upon whether the service/content provider is located in the local service directory domain of the local or remote SIP event server.

Registration of the printer 12 occurs with the printer sending a SIP REGISTER message 70 to remote SIP event server 15 for registering its service capabilities. Note that although the present example concerns service capabilities, registration of content is equally applicable, such as content stored and available for distribution from the registering device. Note further that although shown as a SIP REGISTER message, as applicable, message 70 may also be a SIP PUBLISH message in accordance with extensions to SIP (see, e.g., SIMPLE Presence Publication Mechanism, draft-olson-simple-publish-01, IETF draft Oct. 24, 2002, the contents of which are hereby incorporated by reference in its entirety). In accordance with the SIP infrastructure of the system 10, the printer sends SIP REGISTER message 70, which specifies the URI of the remote SIP event server as the receiver of the registration, to its corresponding SIP proxy 20. The SIP proxy 20, in turn, forwards the SIP REGISTER message to SIP proxy 23, which forwards the SIP REGISTER message to remote SIP event server 15 via IP network 19.

A portion 84 of the payload 78 of the REGISTER message 70 shown in FIG. 5 carries a description of services provided by the printer 12. This description is not restricted to a single service description if the printer is providing several services. The description further contains the URI of the service provider (i.e., printer) for actual service provisioning. The format of portion 84 of the payload may be an attribute-based format, such as those used with Service Location Protocol (SLP), or using a description such as defined in the Resource Description Framework (RDF). For more information on SLP and RDF see Internet Engineering Task Force (IETF) request for comment document 2608, entitled: Service Location Protocol, version 2, June 1999; and Resource Description Framework Model and Syntax Specific, W3C Recommendation, 22 Feb. 1999, respectively, the contents of both of which are hereby incorporated by reference in their entireties. Further, a dedicated format for SIP service descriptions may be used. A dedicated format, however, would require standardization in appropriate standardization bodies, such as Internet Engineering Task Force (IETF). According to the printer example, the format is typically an SLP format to match local repository/service agent 17; although, other formats may alternatively be used.

The payload 78 might further include indications 80, 82 (see FIG. 5) of an event package and/or an event type, respectively. According to an embodiment of the present invention, there are two event packages, namely service packages and content packages. Additionally, there are four event types, namely published or registered, de-registered, requested and request_removed. Using the REGISTER message 70, service(s) and/or content may be registered or de-registered as indicated in the payload. The event types of “requested” and “request_removed” will be discussed further below; however, they are related to subscriptions associated to requests for services and/or content. As discussed above, the event packages and event types might also be given implicitly through portion 84 of the payload, i.e., the indications 80 and 82 are not explicitly given in the SIP REGISTER message 70. Defining these event packages and event types according to this embodiment does not extend the SIP core protocol, rather it defines event packages compliant with IETF request for comment document RFC 3265, entitled: SIP-Specific Event Notification, July 2002, the contents of which are hereby incorporated by reference in its entirety. Hence, implementation of such event packages may be done on the application level. Accordingly, the remote SIP event server 15 represents a SIP user agent that may interpret event messages according to its programming.

Multiple packages and types and may be registered and/or de-registered with remote SIP event server 15 according to the payload of REGISTER message 70. Optionally, the REGISTER message may be mapped to indicated event package and type; however, such mapping would require standardization in appropriate standardization bodies, such as IETF. In an optional embodiment, the SIP REGISTER message contains an “expires” value (not shown) for indicating the length of the registration. Upon expiration of the “expires” value, de-registration may be automatic absent re-registration by the service/content provider. Further, a default expires value may be set in the remote SIP event server as desired.

Upon reception of the REGISTER message 70, the remote SIP event server 15 registers or de-registers (indicated by the event type information in REGISTER message, see FIG. 5) the given service description(s) for the service/content provider 12 by storing 71 such information in the database 56 in memory 52 shown in FIG. 3A. Further, the remote SIP event server forms a service registration or de-registration message 72 for the service/content provider and sends the service registration or de-registration message to the local repository/service agent 17, which acts to register or de-register the service/content provider with local repository/service agent 17. The service registration message 72 is formatted to be appropriate for the local repository/service agent 17 to which it is being sent. For example, it may have one format for an SLP-based service agent and another format for an RDF-based service agent. Accordingly, the remote SIP event server formats the service registration message to meet the protocol appropriate for the local repository/service agent 17, as well as other requirements specific to the local repository/service agent 17.

Use of a common message framework, such as SIP, provides advantages over specialized service discovery procedures. For example, the service/content provider 12 may create a REGISTER message according to a common SIP format without knowledge of specific requirements related to the local repository/service agent 17, and yet service capabilities for the service/content provider may be registered with the local repository/service agent 17. Further, beyond creation of the payload 78 in the SIP REGISTER message 70 (see FIG. 5), registration of its service capabilities may be transparent to the service/content provider.

Mapping of the REGISTER message 70 and the addition of an identifier 86, as shown in FIG. 6, to identify the local repository/service agent 17 in the REGISTER message may be appropriate for interpretation or forwarding of service information by remote SIP event server 15. This may also be done implicitly through the remote SIP event server recognizing the payload format (e.g., SLP, RDP) and making a forwarding decision based on the format. Further, the remote SIP event server may also register the service with all associated local repository/service agents by sending a service registration message 72 in a respective format to each local repository/service agent, which may require an appropriate mapping of the service description format as outlined above for the SIP REGISTER message 70. If the local repository/service agent 17 is co-located with the remote SIP event server, message 72 may not need to be sent. Instead, in such instances, the remote SIP event server implements appropriate local repository/service agent functionality internally.

As an example, the payload of the REGISTER message 70 shown in FIG. 5 may be identifiable by the remote SIP event server 15 as being an SLP-based format. Accordingly, the remote SIP event server may recognize this type of format and therefore send related messages (e.g., service registration, service discovery) only to service agents set up for SLP-based messages. In an optional embodiment, the format type may be identified by a repository/agent identifier 86 within the SIP message having a value associated with a format for the payload, as shown in FIG. 6. As such, the remote SIP event server is able to identify the discovery protocol based on the state of the identifier 86.

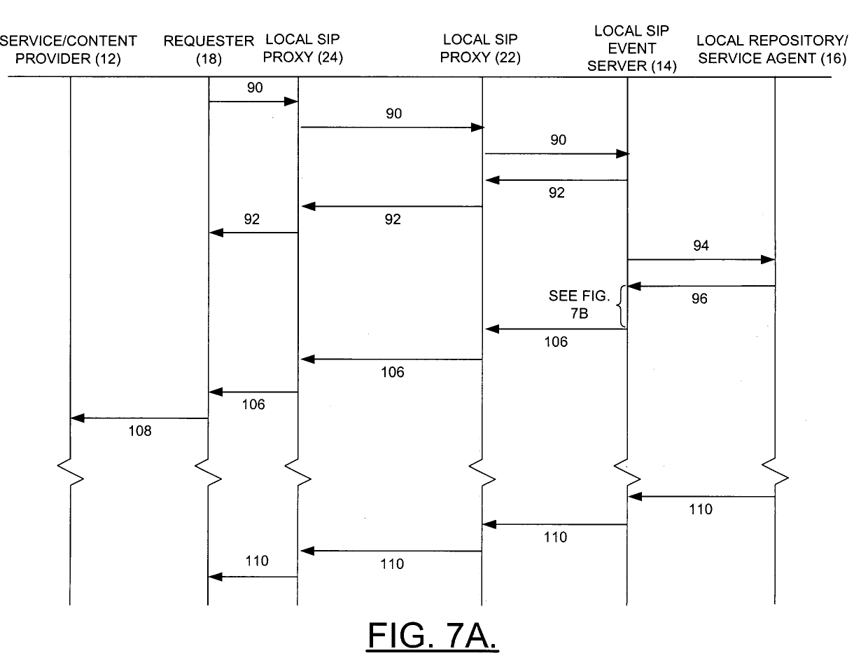

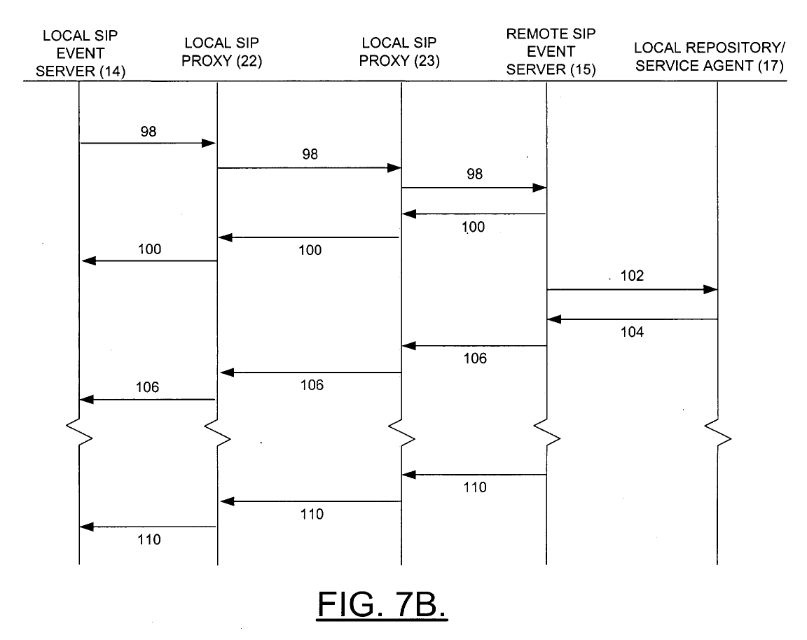

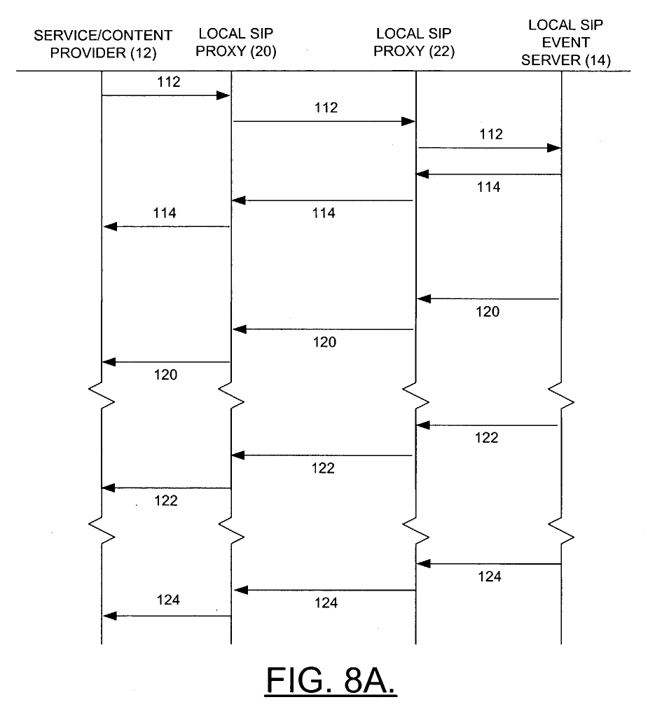

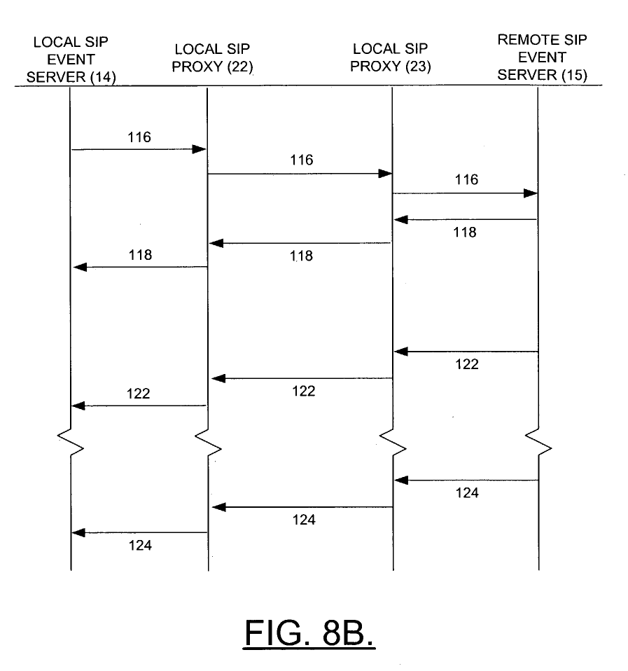

In other embodiments discussed further, upon reception of the REGISTER message 70, the remote SIP event server 15 may compare the newly received service descriptions in the REGISTER message with the existing subscriptions for the published/registered event, which is stored in database 56 of the remote SIP event server. If a matching subscription is found, an appropriate notification is sent to the user associated with the subscription (see messaging associated with FIGS. 7A and 7B and related discussion).

Referring back to FIG. 4, the local repository/service agent 17 typically sends a registration confirmation message 74 to remote SIP event server 15. However, the procedures related to service registration and discovery with the local repository/service agent 17 depend on its particular requirements, which might not support registration confirmation. In a SIP environment, the remote SIP event server sends a response message 76 to the service/content provider 12, such as a ‘200 OK’ return code indicating a successful registration/publication. This message is forwarded appropriately back to service/content provider.

The same message sequence is used for de-registration of services. In such a scenario, the REGISTER or PUBLISH message 70 contains appropriate information to indicate the de-registration of the contained service specification. Message 72 may be appropriately adapted to de-register the service from the local repository/service agent 17. Further, the local database 56 in memory 52 of the remote SIP event server 15 is checked, similar to the registration case, for a matching subscription for the de-registered event, and appropriate notifications are sent as shown in FIGS. 7A and 7B and discussed below.

Note that it is also possible to register services and/or content according to other embodiments without using the above mentioned SIP methods. Suppose, as an example, that registration is based on another method, such as SLP messaging. Accordingly, upon reception of the corresponding SLP registration message, the remote SIP event server 15 proceeds as if message 70 of the method shown in FIG. 4 had been received. For example, the remote SIP event server proceeds to send the service registration message 72 to the local repository/service agent 17.

Referring now to FIGS. 7A and 7B in particular, as well as FIGS. 1-3 in general, message flows for a service and/or content subscription/notification method according to another embodiment of the present invention are shown. According to this method, the requester 18 may subscribe to notifications for particular events. As such, the requester receives notifications related to subscribed-to events at periodic intervals, such as at pre-defined intervals or when the status changes for subscribed-to events. For instance, returning to the printer scenario of FIG. 4, suppose that the requester is a mobile station. Suppose further that the mobile station is registered with a remote SIP proxy (not shown) while the user is traveling in his car and suppose that the user receives an email while traveling in his car. Suppose also that the email contains color photograph information, but that the mobile station does not have the capability to print the email including the color photograph information. Suppose further that when the user arrives at his company at facility B, the user is handed over to the company's private network at facility B by applying known mobile IP techniques such that the mobile station registers with local SIP proxy 24. With reference to FIGS. 1-3, also suppose that the local SIP event server 14 (and local repository/service agent 16) is within the local service directory domain of facility B, and thus the mobile station, while the remote SIP event server 15 (and local repository/service agent 17), with which the color printer is registered, is within the local service directory domain of facility A.

In order to locate an available color printer to print his email, the user will typically attempt to subscribe to local SIP event server 14 for notifications of a service event for available color printers. Accordingly, when registering with the company's private network at facility B, the mobile station obtains the address of local SIP event server that communicates with local repositories/service agents throughout facility B of the company. In particular, local SIP event server communicates with local repository/service agent 16, which supports devices within the user's physical location within the company network of facility B. In order to attempt to locate a color printer, the mobile station sends a SUBSCRIBE message 90 to its corresponding local SIP proxy 24, which contains as a payload the description of the desired service (e.g. color printer service) and the event of interest, for example registered/published or de-registered. The SUBSCRIBE message may contain an “expires” parameter (not shown) indicating duration of the subscription. Depending on the length of the subscription, the mobile station (i.e., requester 18) may receive periodic notifications in response to changes for the event or may receive a one-time notification of available color printers.

The SUBSCRIBE message 90 according to this embodiment may be a message that is part of an extension to SIP as defined in IETF's request for comment document RFC 3265, entitled: SIP-Specific Event Notification, dated June 2002, the contents of which are hereby incorporated by reference in its entirety. The format of the service description in the payload may include, for example, attribute-based formats such as used in SLP or RDF-based formats or a dedicated format for SIP service description. The SUBSCRIBE message is appropriately forwarded to the local SIP event server 14 via proxies 24 and 22. Upon reception of the SUBSCRIBE message, the local SIP event server 14 stores the subscription for the specified event (e.g., published/registered, de-registered) in the local database 56 stored in memory 52 (shown in FIG. 3). The associated description and the expiration time for the subscription are also stored in the local database.

Upon reception of the SUBSCRIBE message 90, the local SIP event server 14 appropriately confirms reception with a ‘200 OK’ message 92 sent to the requester 18 via proxies 22 and 24. Presuming, then, that the requester 18 subscribed for a published/registered event, the local SIP event server 14 further sends a service discovery message 94 to the associated local repository/service agent 16 to perform a match with the service requested. Note that an appropriate mapping might be necessary from the input representation of the service description given in SUBSCRIBE message 90 to the required service description of the local repository 16. This may be particularly true if the repository 16 represents a service discovery agent of a particular format (e.g., SLP, RDP). In the presence of several associated repositories (not shown), message 90 may include an appropriate identifier (not shown) to decide which one of the associated repositories is to be used. This can be done explicitly as discussed with FIG. 6 above for REGISTER message 70. It may further be accomplished implicitly via local SIP event server recognizing the payload format and making the decision based on the recognized format.

In an alternate embodiment, the local SIP event server 14 may discover the service/content requested with all local repositories having the identified or recognized format by sending service discovery messages 94 to all associated local repositories/service agents. For that, an appropriate mapping of the service description format might be necessary as outlined above. If the repository functionality is co-located with the local SIP event server, message 94 might not need to be sent. The local repository/service agent 16 subsequently sends a service discovery response message 96 to the local SIP event server describing devices that meet the requested requirements, if any exist. The format of the response message 96 may be an attribute-based format such as used in SLP-based formats, or in an description format such as used in RDF-based formats. In addition, a dedicated SIP service description format may be used, which might require standardization in appropriate standardization bodies, such as IETF.

If several requests have been sent to several associated repositories/agents 16, the local SIP event server 14 may wait for responses from all these agents. Note that an appropriate mapping of the service description format used by the local repositories/service discovery agents 16 onto the service description format employed by the request may be required. For example, attribute-based formats such as used in SLP or RDF-based formats may be used, as may a dedicated format for SIP service description.

Upon reception of all repository responses 96, the local SIP event server 14 sends a NOTIFY message back to the requester 18 via proxies 22 and 24. For more information on such an instance, see U.S. patent application Ser. No. 10/330,146. Presume, however, that there has been no match for the requested services/content. According to embodiments of the present invention, as shown in FIG. 7B, the local SEP event server formats a new SUBSCRIBE message 98 that includes the same information as received from the requester, but designates the local SIP event server as the requester. The local SIP event server then transmits the SUBSCRIBE message 98 to one or more remote SIP event servers 15 (only one of which is shown in FIG. 7B), in accordance with the federation logic 64. Continuing operation, then, the local SIP event server now logically acts as the requester to the remote SIP event server. The SUBSCRIBE message 98 is appropriately forwarded to the remote SIP event server 15 via proxies 22 and 23. Upon reception of the SUBSCRIBE message 98, the remote SIP event server 15 stores the subscription for the specified event (e.g., published/registered, de-registered), along with the associated description and the expiration time for the subscription, in the local database 56 stored in memory 52 (shown in FIG. 3) of the remote SIP event server.

Upon reception of the SUBSCRIBE message 98, the remote SIP event server 15 appropriately confirms reception with a ‘200 OK’ message 100 sent to the local SIP event server 14 via proxies 23 and 22. Remembering that the requester 18, and thus the local SIP event server, subscribed for a published/registered event, the remote SIP event server further sends a service discovery message 102 to the associated local repository/service agent 17 to perform a match with the service requested. Note again that an appropriate mapping might be necessary from the input representation of the service description given in SUBSCRIBE message 98 to the required service description of the local repository 17. Also, as before with the local SIP event server, in the presence of several associated repositories (not shown), message 98 may include an appropriate identifier, either explicit or implicit, to decide which one of the associated repositories is to be used.

Also as before, in an alternate embodiment, the remote SIP event server 15 may discover the service/content requested with all local repositories having the identified or recognized format by sending service discovery messages 102 to all associated local repositories/service agents. For that, an appropriate mapping of the service description format might be necessary as outlined above. If the repository functionality is co-located with the remote SIP event server, message 102 might not need to be sent. The local repository/service agent 17 subsequently sends a service discovery response message 104 to the local SIP event server describing devices that meet the requested requirements, if any exist. The format of the response message 104 may be an attribute-based format such as used in SLP or RDF-based formats. In addition, a dedicated SIP service description format may be used, which might require standardization in appropriate standardization bodies, such as IETF.

If several requests have been sent to several associated repositories/agents 17, the remote SIP event server 15 may wait for responses from all these agents. It will again be noted that an appropriate mapping of the service description format used by the local repositories/service discovery agents 17 onto the service description format employed by the request may be required. Upon reception of all repository responses 104, the remote SIP event server 15 sends a NOTIFY message 106 back to the local SIP event server 14 via proxies 23 and 22. In turn, the local SIP event server can send the NOTIFY message to the requester 18 via proxies 22 and 24, as shown in FIG. 7A. This message contains the description of found services and the triggered event (in this case registered/published) in an appropriate format. It further contains the contact URI(s) provided in the service registration(s) of the service provider(s), such as service/content provider 12 (e.g., color printer). If there has been no match for the requested services/content, the payload contains an appropriate indication. The NOTIFY message is appropriately routed through the SIP proxies 23, 22 to the local SIP event server, and through proxies 22, 24 to the requester. Upon reception of NOTIFY message, a respective application (not shown) on the requester extracts the received service descriptions and the contact URI for further use, if available. For instance, the requester may subsequently contact the service provider using a SIP INVITE message 108.

It will be appreciated that one embodiment of the present invention allows for a one-time discovery request/response scheme, which may be referred to as a QUERY. For a QUERY, requester 18 sends a SUBSCRIBE message 90 for a published/registered event in which an expiration time of zero is specified for the subscription. In such an instance, in this embodiment, the subscription is not stored in the local database of either the local SIP event server 14 or the remote SIP event server 15. Thus, only the service lookup with local repository/service agents 16, 17 is performed, leading to an appropriate NOTIFY message 106 that is sent to requester 18 through the local SIP event server.

If the subscription in message 90 has not been a one-shot subscription, i.e., a non-zero expiration time has been given in message 90, the remote SIP event server 15, and thus the local SIP event server 14 has to perform appropriate matching functions upon reception of new service registrations or de-registrations, as outlined above. Hence, if a new service registration or de-registration is received, the local and remote SIP event servers compare the service characteristics with the stored subscriptions for the appropriate event (i.e., registered/published for service registrations and de-registered for service de-registrations), with the remote SIP event server subsequently generating appropriate NOTIFY messages 110 that are sent to subscribed requesters 18. These messages are appropriately routed through the SIP proxies 23, 22 to local SIP event server 14, and through SIP proxies 22, 24 to the requester 18, therefore notifying requester of available or de-registered services that met the given characteristics of the subscription. Accordingly, a requester application (not shown) extracts the received service descriptions and the contact URI for further use, if available, for instance to contact service provider 12. If a stored subscription with either the remote SIP event server or the local SIP event server expires, typically occurring concurrently, the remote SIP event server or the local SIP event server, respectively, may remove the appropriate subscription from its local database.

In the present example, suppose local repository/service agent 17 determines that service provider 12 meets the color printer requirements for the email as requested. As such, the local repository/service agent 17 returns the URL for the color printer in response message 104. The remote SIP event server 15, in turn, sends a NOTIFY message 106 to the local SIP event server 14, which in turn, sends the NOTIFY message to the mobile station (i.e., requester 18) describing all found services that meet desired service requirements, which in this example includes the color printer. Upon reception of the NOTIFY message 106, the mobile station extracts received service descriptions, which in this example include the URL for the color printer. The mobile station can now initiate the transfer of the color photograph information from the caller to the IP color printer by sending a SIP INVITE message 108 to the IP-enabled color printer.

According to another method of service and/or content subscription/notification of service requests, a service/content provider 12 may subscribe to service requests that have been published by requesters within the local service discovery domain or by requesters within the service discovery domain of remote event servers 15, in accordance with embodiments of the present invention. As such, the service/content provider receives notifications related to subscribed-to events at periodic intervals, such as at pre-defined intervals or when the status changes for subscribed-to events. For instance, returning to the printer scenario of FIGS. 4 and 7, suppose that service/content provider 12 (color printer) registered with the local SIP event server 14, i.e., SIP event server within the local service discovery domain of the service/content provider. Also suppose that the service/content provider has subscribed to a “requested” event for color printing service requests from any facility in the company, including both facility A and facility B. As such, when the mobile station (i.e., requester 18) subscribes to an event for color printing services, the color printer will automatically be notified of such service request. The color printer may therefore choose to contact the mobile station at facility A directly, or may prepare itself for providing such a service.

As shown in FIG. 8, a service/content provider 12 sends a SUBSCRIBE message 112 for the appropriate event, i.e., “requested” or “request-removed,” to the local SIP event server 14 via SIP proxies 20, 22. As with the previous embodiment, the message body of the SUBSCRIBE message contains the service and/or content information to which the service/content provider subscribes. As discussed with the previous embodiment, the local SIP event server can respond with a 200 OK message 114 to the service/content provider sent via SIP proxies 22, 20. Upon reception of the SUBSCRIBE message 112, for a requested event, the local SIP event server 14 can check its local subscription database 56 for matching entries. For more information on such a method utilizing the local SIP event server, see U.S. patent application Ser. No. 10/330,146.

In addition to checking its local subscription database, in accordance with embodiments of the present invention, as shown in FIG. 8B, the local SIP event server can format a new SUBSCRIBE message 116 that includes the same information as received from the service/content provider 12, but designates the local SIP event server as the service/content provider. The local SIP event server then transmits the SUBSCRIBE message 116 to one or more remote SIP event servers 15 via proxies 22, 23 (only one of which is shown in FIG. 8B), in accordance with the federation logic 64. Upon reception of the SUBSCRIBE message 116, the remote SIP event server stores the subscription for the specified event. Additionally, the remote SIP event server appropriately confirms reception with a ‘200 OK’ message 118 sent to the local SIP event server 14 via proxies 23 and 22. Like the local SIP event server, the remote SIP event server checks its local subscription database 56 for matching entries.

If there are any matching entries from the local SIP event server 14, the local SIP event server returns such information to the content/service provider 12 in the message body of a NOTIFY message 120, which is forwarded to the service/content provider via SIP proxies 22, 20. For a request_removed event, the local SIP event server simply responds with a NOTIFY message that contains an empty message body because there will yet not have been any removals. For both events, the local SIP event server stores the subscription in its local database 56 for further notifications.

Like the local SIP event server 14, if the remote SIP event server 15 finds any matching entries, the remote SIP event server returns such information to the local SIP event server in the message body of a NOTIFY message 122, which is forwarded to the local SIP event server via SIP proxies 23, 22. The local SIP event server can react to the NOTIFY message 122 in any number of manners. For example, the local SIP event server can wait for NOTIFY message 122 before sending NOTIFY message 120, and upon receipt of NOTIFY message 122, aggregate the message bodies of NOTIFY messages 120 and 122. The aggregate NOTIFY message can then be sent to the service/content provider 12. Alternatively, and as shown, the local SIP event server can forward the NOTIFY message 122 to the service/content provider via SIP proxies 23, 20. Like with the local SIP event server, for a request_removed event, the remote SIP event server simply responds with a NOTIFY message that contains an empty message body because there will yet not have been any removals. For both events, also like the local SIP event server, the remote SIP event server stores the subscription in its local database 56 for further notifications.

If there are any incoming service discovery requests to the remote SIP event server 15, or if there are any removals of subscriptions to those events, the remote SIP event server checks those incoming subscriptions against the subscriptions for the requested or request_removed events, and thereafter generates appropriate NOTIFY messages 124. Subsequent NOTIFY messages 124 are sent to the local SIP event server 14 for appropriate subscriptions, and from the local SIP event server, to the respective service/content provider(s) 12, that subscribed to those events. The message body of those notifications contains information about the content and/or service(s) requested and the requester(s) identification (e.g., URIs).

As indicated above with respect to FIG. 3B, the local and/or remote SIP event servers 14, 15 may include a cache 66. As described above, the cache may facilitate optimization of service and/or content discovery by storing a listing of the services and/or content previously discovered at other, remote SIP event servers. More particularly, the local SIP event server can store the payloads of the NOTIFY messages 106, along with the URI of the remote servers from whom the local SIP event server received the respective NOTIFY messages. As will be appreciated, such an instance typically applies to instances in which the local SIP event server sends a SUBSCRIPTION message 98 to more than one remote SIP event server. When the local SIP event server receives NOTIFY messages from remote SIP event servers, then, the local SIP event server can extract the payload of the NOTIFY message, and appropriately update the cache. Thus, the local SIP event server maintains an updated knowledge of the service/content offerings of the remote SIP event servers for specified requests.

In operation, then, presume that the requested services/content are not matched to a local repository/service discovery agent 16 by the local SIP event server 14. In such instances, according to this embodiment, the local SIP event server can advantageously first consult the internal cache 66 to thereby attempt to locate the requested services/content via a remote SIP event server that previously discovered such services/content. If the cache includes an entry for the requested services/content, the contents of the previous NOTIFY message including the requested services/content is sent to the requester 18 via proxies 22 and 24. If the cache does not include a listing for the requested services/content, however, the method can proceed as before with the local SIP event server sending the SUBSCRIBE message 98 to one or more remote SIP event servers 15.

As will be appreciated, the present invention is fully applicable to a wide range of services and content, as well as to other types of discoverable information. As an additional example, suppose the remote SIP event server 15 serves a network for a large shopping mall. Suppose many of the stores and merchants associated with the mall maintain various service/content providers 12. For instance, movie theaters may maintain servers that provide content related to movie schedules, prices, movie trailers, etc. In addition, retail stores may maintain servers that provide content related to store specials, coupons, etc. Further, service kiosks may provide services, such as printing services, computing or teleconferencing services.

Each of these entities may register their servers and devices with one or more local repositories 17, which may operate with specific discovery protocols. Many of these entities may also subscribe to events with the remote SIP event server 15. For example, a service kiosk may use a computer to subscribe to multiple service request events, and as such may receive notifications whenever requesters request certain services, such as printing, computing, or teleconferencing services. Under such a scenario, a user of a mobile station (requester 18) may request a wide variety of content and/or services to enhance their shopping experience. From the perspective of the mobile station user, content and services may easily be discovered using SIP messaging regardless of particular discovery protocols used by the repositories 17.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for subscribing to an event maintained by a remote event server across a local service discovery domain, the method comprising:
receiving, at a local event server from a first network entity, a subscription message subscribing to the event, the message having an event package description, an event type description, and a description for one of a service and a content requested;
transmitting a subscription message to at least one remote event server located in a different local service discovery domain than the local event server, wherein the subscription message includes the event package, the corresponding event type and the one of the service and content requested; and
sending a first notify message to at least one of the local event server and the to first network entity.

2. A method according to claim 1 further comprising checking for a match, at the at least one remote event server, for the event package, the corresponding event type, and the one of the service and content requested after transmitting the subscription message to at least one remote server, wherein sending a first notify message comprises sending a first notify message indicating whether the match was located.

3. A method according to claim 1 further comprising checking for a match, at the local event server, for the event package, the corresponding event type, and the one of the service and content requested, wherein checking for a match occurs before transmitting a subscription message, and wherein transmitting a subscription message comprises transmitting a subscription message when no match is located.

4. A method according to claim 3 further comprising:
checking a cache, at the local event server, for a match for the event package, the corresponding event type, and the one of the service and content requested after checking for and failing to locate a match, at the local event server, for the event package, the corresponding event type, and the one of the service and content requested,
wherein transmitting a subscription message occurs when no match is found in the cache, and wherein sending a first notify message comprises sending a first notify message from the local event server to the first network entity when a match is found in the cache.

5. A method according to claim 1, wherein receiving a subscription message comprises receiving, at the local event server from a requester, a subscription message subscribing to the event, and wherein the message includes an event type description comprising at least one of a registered type and a published type.

6. A method according to claim 5 further comprising:
checking for a match, at the local event server, before transmitting a subscription message, wherein transmitting a subscription message comprises transmitting a subscription message when no match is located, wherein checking for a match comprises:
sending a discovery message to a repository, the discovery message requesting information about at least one provider matching the one of the service and content requested; and
receiving a discovery response from the repository, wherein the discovery response is generated in response to the repository checking for a match for the at least one of the service and content requested, and wherein the discovery response contains one of an indication of a non-existing match and at least one provider at least partially matching the one of service and content requested.

7. A method according to claim 5 further comprising:
receiving, at the remote event server, a register message from a provider, wherein the register message comprises an event package description describing an event package comprising one of a service event package and a content event package, an event type description describing a register event type, and one of service and content capability for the provider;
checking for a service/content match of the one of the service and the content capability information for the provider; and
notifying the requester when a service/content match is located and the service/content match includes at least a partial match with one of the service and the content requested by the requester.

8. A method according to claim 1, wherein receiving a subscription message comprises receiving a subscription message further including an expiration time for expiration of the subscription to the event, and wherein the method further comprises:
receiving a register message, at the remote event server from a second network entity, wherein the register message comprises one of service and content capability information for the second network entity at least partially matching the one of the service and content requested from the first network entity; and
sending a second notify message notifying the first network entity of the match with the one of the service and content capability information for the second network entity when the expiration time has not expired.

9. A method according to claim 1, wherein receiving a subscription message comprises receiving, at the local event server from a requester, a subscription message subscribing to the event, the message having an event type description comprising a de-registered type, the method further comprising:
receiving a register message, at the remote event server from a provider, comprising one of service and content capability information for the provider and an event type description describing a de-register event type, wherein the service and content capability information for the provider matches the service and content requested for the requester;
checking for a service/content match of the one of service and content capability information for the provider; and
notifying the requester of the de-registered state of the provider when the service/content match is located.

10. A method according to claim 9, wherein checking for a service/content match comprises comparing, at the remote event server, the service and content capability information for the provider with a subscription database.

11. A method according to claim 1, wherein receiving a subscription message comprises receiving, at the local event server from a provider, a subscription message subscribing to the event, the message having an event type description comprising a requested type.

12. A method according to claim 11 further comprising:
receiving, at the remote event server from a requester, a subscription message comprising an event package description, an event type description describing one of a registered event type and a published event type, and a description for one of a service and a content requested;
checking for a service/content match of one of the service and the content requested by the requester; and
notifying the provider of the subscription message from the requester when a service/content match is located and the match includes at least a partial match with one of the service and the content requested by the requester.

13. A method according to claim 1, wherein receiving a subscription message comprises receiving, at the local event server from a provider, a subscription message subscribing to the event, the message having an event type description comprising a request_removed type, wherein the method further comprises:
receiving, at the remote event server from a requester, a second subscription message requesting removal of a first subscription request requesting one of the service and the content;
checking for a service/content match of one of the service and the content requested in the first subscription request by the requester; and
notifying the provider of the subscription removal message from the requester when a service/content match is located and the match includes at least a partial match with one of the service and the content requested by the requester.

14. A method according to claim 1, wherein receiving a subscription message comprises receiving, at a session initiation protocol (SIP) local event server, a subscription message comprising a SIP SUBSCRIBE message.

15. A method according to claim 14, wherein sending a first notify message comprises sending a SIP NOTIFY message.

16. A method according to claim 1, wherein receiving a subscription message comprises receiving a subscription message including a description for one of a service and a content requested in at least one of an attribute-based format and a description format.

17. A method according to claim 16, wherein receiving a subscription message including a description for one of a service and a content requested having a format selected from the group consisting of Service Location Protocol (SLP) and Resource Description Framework (RDF).

18. A system for subscribing to an event across a local service discovery domain, the system comprising:
a first network entity capable of transmitting a subscription message subscribing to the event, the message having an event package description, an event type description, and a description for one of a service and a content requested;
a local event server capable of receiving the subscription message, and thereafter transmitting a subscription message, wherein the subscription message includes the event package, the corresponding event type and the one of the service and content requested; and
a remote event server located in a different local service discovery domain than the local event server, wherein the remote event server is capable of receiving the subscription message from the local event server, and sending a first notify message to at least one of the local event server and the first network entity.

19. A system according to claim 18, wherein the remote server is capable of checking for a match for the event package, the corresponding event type, and the one of the service and content requested, and wherein the remote server is capable of sending a first notify message indicating whether the match was located.

20. A system according to claim 18, wherein the local event server is capable of checking for a match for the event package, the corresponding event type, and the one of the service and content requested after receiving the subscription message, and wherein the local event server is capable of transmitting a subscription message when no match is located.

21. A system according to claim 20, wherein the local event server is capable of checking a cache for a match when no match is located for the event package, the corresponding event type, and the one of the service and content requested, wherein the local event server transmits the subscription message when no match is found in the cache, and wherein the local event server is capable of sending a first notify message to the first network entity when a match is found in the cache.

22. A system according to claim 18, wherein the first network entity comprises a requester, and wherein the requester is capable of transmitting a subscription message including an event type description comprising at least one of a registered type and a published type.

23. A system according to claim 22, wherein the local event server is capable of checking for a match before transmitting a subscription message, wherein the local event server is capable of transmitting the subscription message when no match is located, wherein the system further comprises:
a repository capable of receiving, from the local event server, a discovery message requesting information about at least one provider matching the one of the service and content requested, wherein the repository is capable of checking for a match for the at least one of the service and content requested, and thereafter transmitting a discovery response containing one of an indication of a non-existing match and at least one provider at least partially matching the one of service and content requested, and wherein the local event server is capable of receiving the discovery response to thereby check for the match.

24. A system according to claim 22 further comprising:
a provider capable of transmitting, to the remote event server, a register message comprising an event package description describing an event package comprising one of a service event package and a content event package, an event type description describing a register event, and one of service and content capability for the provider,
wherein the remote event server is capable of checking for a service/content match of the one of the service and the content capability information for the provider, and wherein the remote event server is capable of notifying the requester when a service/content match is located and the service/content match includes at least a partial match with one of the service and the content requested by the requester.

25. A system according to claim 18, wherein the first network entity is capable of transmitting a subscription message further including an expiration time for expiration of the subscription to the event, and wherein the remote event server is capable of receiving a register message from a second network entity, wherein the register message comprises one of service and content capability information for the second network entity at least partially matching the one of the service and content requested from the first network entity, and wherein the remote event server is capable of sending a second notify message notifying the first network entity of the match with the one of the service and content capability information for the second network entity when the expiration time has not expired.

26. A system according to claim 18, wherein the first network entity comprises a requester, wherein the requester is capable of transmitting a subscription message having an event type description comprising a de-registered type, the system further comprising:
a provider capable of transmitting, to the remote event server, a register message comprising one of service and content capability information for the provider and an event type description describing a de-register event type, wherein the service and content capability information for the provider matches the service and content requested for the requester,
wherein the remote event server is capable of checking for a service/content match of the one of service and content capability information for the provider, and thereafter notifying the requester of the de-registered state of the provider when the service/content match is located.

27. A system according to claim 26, wherein the remote event server is capable of checking for a service/content match by comparing the service and content capability information for the provider with a subscription database.

28. A system according to claim 18, wherein the first network entity is capable of transmitting a subscription message having an event type description comprising a requested type.

29. A system according to claim 28 further comprising:
a requester capable of transmitting a subscription message to the remote event server, wherein the subscription message comprises an event package description, an event type description describing one of a registered event type and a published event type, and a description for one of a service and a content requested,
wherein the remote event server is capable of checking for a service/content match of one of the service and the content requested by the requester, and wherein the remote event server is capable of notifying the provider of the subscription message from the requester when a service/content match is located and the match includes at least a partial match with one of the service and the content requested by the requester.

30. A system according to claim 18, wherein the first network entity is capable of transmitting a subscription message having an event type description comprising a request_removed type, wherein the system further comprises:
a requester capable of transmitting a second subscription message to the remote event server, wherein the second subscription message requests removal of a first subscription request requesting one of the service and the content,
wherein the remote event server is capable of checking for a service/content match of one of the service and the content requested in the first subscription request by the requester, and wherein the remote event server is capable of notifying the provider of the subscription removal message from the requester when a service/content match is located and the match includes at least a partial match with one of the service and the content requested by the requester.

31. A system according to claim 18, wherein the first network entity is capable of transmitting a session initiation protocol (SIP) SUBSCRIBE message, and wherein the local event server comprises a SIP event server.

32. A system according to claim 31, wherein the remote event server is capable of sending a first notify message comprising a SIP NOTIFY message.

33. A system according to claim 18, wherein the first network entity is capable of transmitting a subscription message including a description for one of a service and a content requested in at least one of an attribute-based format and a description format.

34. A system according to claim 33, wherein the subscription message includes a description for one of a service and a content requested having a format selected from the group consisting of Service Location Protocol (SLP) and Resource Description Framework (RDF).

35. A local event server capable of facilitating subscribing to an event across a local service discovery domain, the event associated with at least one of services and content available within a network, the local event server comprising:
a processor capable of receiving, from a first network entity, a subscription message subscribing to the event, the message having an event package description, an event type description, and a description for one of a service and a content requested, wherein the processor is capable of checking for a match for the event package, the corresponding event type, and the one of the service and content requested, and wherein the processor is also capable of transmitting a subscription message to at least one remote event server when no match is located such that the remote event server can send a first notify message to at least one of the local event server and the first network entity.

36. A local event server according to claim 35 further comprising:
a cache capable of storing at least one listing for an event package, a corresponding event type, and a corresponding one of the service and content,
wherein the processor is capable of checking the cache for a match when no match is located for the event package, the corresponding event type, and the one of the service and content requested, wherein the processor is capable of transmitting the subscription message when no match is found in the cache, and wherein the processor is capable of sending a first notify message to the first network entity when a match is found in the cache.
